(19) United States
(12) Patent Application Publication
(10) Pub. No.: US 2015/0330129 A1
(43) Pub. Date: Nov. 19, 2015

(54) Adjustable Hinge

(71) Applicant: Thomas Leroy Hendrickson, JR., Phoenix, AZ (US)

(72) Inventor: Thomas Leroy Hendrickson, JR., Phoenix, AZ (US)

(21) Appl. No.: 14/280,557

(22) Filed: May 16, 2014

(51) Int. Cl. E05D 7/00; E05D 3/02

(52) U.S. Cl. CPC E05D 7/0027; E05D 3/02; E05D 2007/0036

(57) ABSTRACT

A mechanism for providing a means of adjusting the vertical height of a hinged door having a jamb leaf (15) with jamb leaf pin barrels (25), (30) and (35) attached to a door leaf (40) with door leaf pin barrels (45) and (50) by means of a threaded hinge pin (20) penetrating leaf pin barrels (25), (30),(35),(45) and (50). A means (55) and (60), containing set screws (75) and (80), of adjusting the vertical height of one leaf (40) in relation to the other leaf (15). A means (70),(72), (65) and (68) of mounting said adjustable hinge to a door (85) and door jamb (90).

### CROSS-REFERENCE TO RELATED APPLICATIONS

None

### BACKGROUND

1. Field of Invention

This invention relates to hinges, specifically to hinges used for doors.

2. Description of Prior Art

For years, door hinges have operated much the same way. A notch is made on the edge of a door as well as the door jamb to accommodate the hinge leafs and allow the hinge leafs to sit flush with the door edge and jamb. Once the hinge is mounted into place, there is very little room for adjustment and if adjustment is needed, further machining of the door and jamb must be made in order for the door to fit properly into the door jamb. Several attempts at solving this problem have been made such as displayed in U.S. Pat. Nos. 7,350,272, 994,196, 2,940,115, 5,799,370 and 6,202,255. These solve the problem, but with considerable retooling of the door and door jamb. The closest invention to this one is U.S. Pat. No. 928,760 (W. F. Hunter) Hunter's hinge solves the problem, but again because of the thickness of his hinge, it would require re-machining a door and door jamb. U.S. Pat. No. 2,373,955 shows a similar mechanism, but requires the hinge pin to be turned in order to adjust the height of the door. This is impractical because the hinge pin should stay rigid in relation to one of the hinge leafs to be stable. This invention solves this problem by providing a mechanism which allows a hinge to be adjusted vertically after the hinge has been mounted and without the need for re-machining the door or door jamb.

### SUMMARY

This invention is a hinge with a mechanism allowing for vertical adjustment of the hinge leafs.

### OBJECTS AND ADVANTAGES

Several objects and advantages of the present invention are:
a) to provide a mechanism for adjusting a door vertically after its hinges have been installed.
b) to provide a means for said mechanism to adjust a door vertically with out further machining of a door or its jamb.
c) to provide said mechanism to the marketplace in a way that it can replace existing hinges without further machining of a door or its jamb

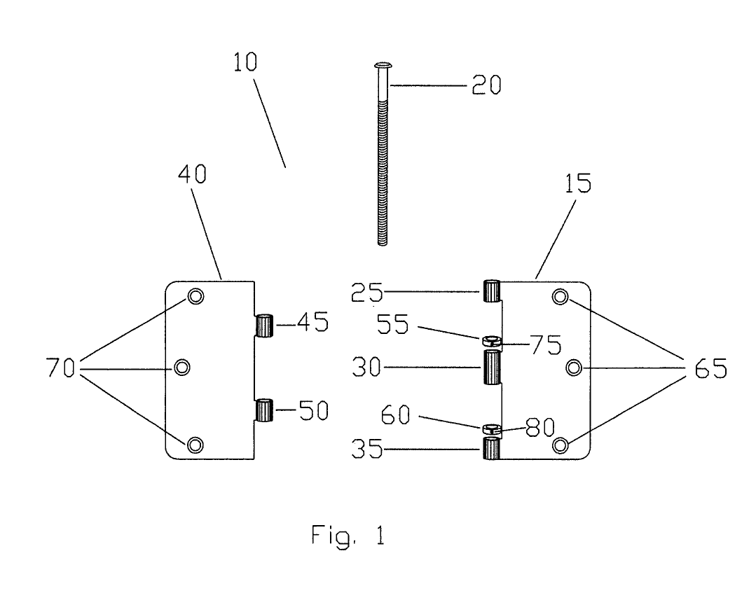

FIG. 1 is an exploded view of an Adjustable Hinge

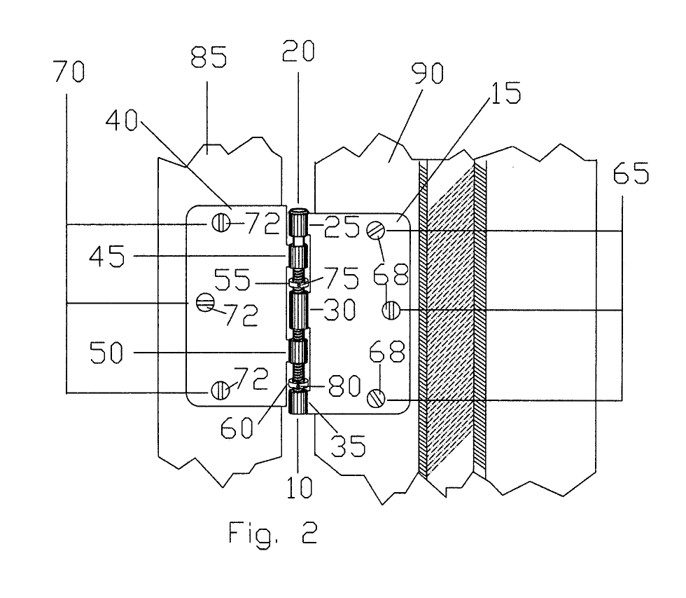

FIG. 2 is a view of an Adjustable Hinge attached to a door and a door jamb.

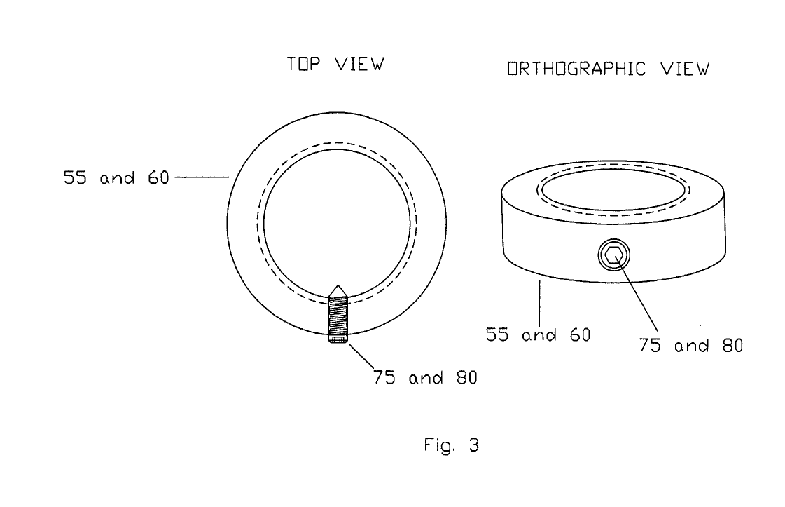

FIG. 3 is a detail top and orthographic view of an adjusting nut and adjusting nut set screw.

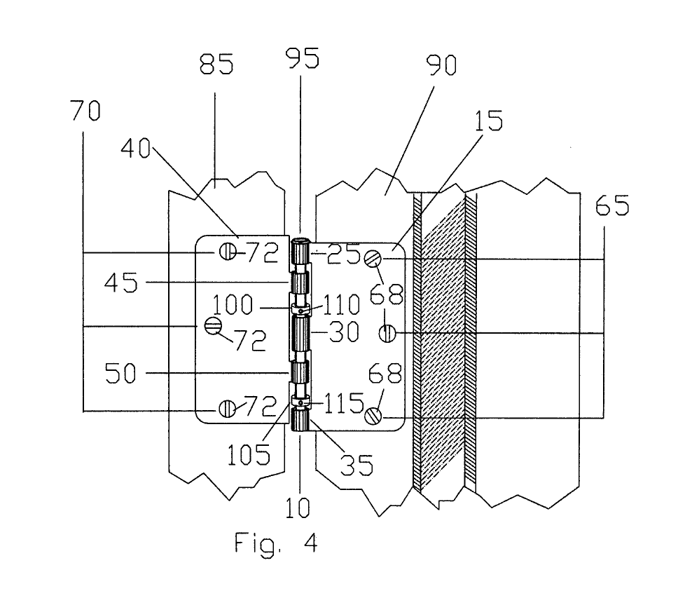

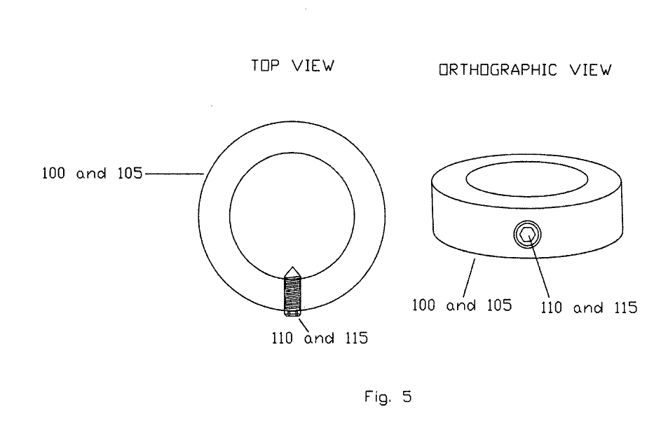

FIGS. 4 and 5 show an alternate embodiment of my invention.

### REFERENCE NUMERALS IN DRAWINGS

10 adjustable hinge
15 jamb leaf
20 threaded hinge pin
25 jamb leaf pin barrel
30 jamb leaf pin barrel
35 jamb leaf pin barrel
40 door leaf
45 door leaf pin barrel
50 door leaf pin barrel
55 threaded adjusting nut
60 threaded adjusting nut
65 jamb leaf mounting holes
68 jamb leaf mounting screws
70 door leaf mounting holes
72 door leaf mounting screws
75 adjusting nut set screw
80 adjusting nut set screw
85 door edge
90 door jamb
95 smooth hinge pin
100 shaft collar
105 shaft collar
110 shaft collar set screw
115 shaft collar set screw

### DESCRIPTION

FIGS. 1, 2 and 3 Preferred Embodiment

A preferred embodiment of the mechanism is illustrated in FIGS. 1 (exploded view of an adjustable hinge), 2 (view of an adjustable hinge mounted to a door and respective door jamb) and 3 (detail of adjusting nut and adjusting nut set screw showing top and orthographic views).

A jamb leaf 15 is connected to pin barrels 25, 30, and 35. A door leaf 40 is connected to pin barrels 45 and 50. A jamb leaf 15 and a door leaf 40 are connected to one another by a threaded hinge pin 20 which penetrates pin barrels 25, 45, 30, 50 and 35. Adjusting nuts 55 and 60 are threaded onto a threaded hinge pin 20 in such a manner that adjusting nut 55 resides between the bottom of door leaf pin barrel 45 and the top of jamb leaf pin barrel 30 and adjusting nut 60 resides between the bottom of door leaf pin barrel 50 and the top of jamb leaf pin barrel 35. A threaded hinge pin 20 is rigidly attached to jamb leaf pin barrels 25, 30 and 35 in such a manner that said threaded hinge pin 20 does not pivot within pin barrels 25, 30 and 35. Openings of door leaf pin barrels 45 and 50 are made large enough to allow pin barrels 45 and 50 and thus door leaf 40 to pivot freely about threaded hinge pin 20. Door leaf pin barrel 45 is penetrated by a threaded hinge pin 20 in such a manner that it resides between jamb leaf pin barrel 25 and adjusting nut 55. Door leaf pin barrel 45 is made short enough in relation to the space between jamb leaf pin barrels 25 and 30 as to allow for vertical movement along a threaded hinge pin 20. Likewise door leaf barrel 50 is penetrated by a threaded hinge pin 20 in such a manner that it resides between jamb leaf pin barrels 30 and adjusting nut 60. Door leaf pin barrel 50 is made short enough to allow for vertical movement along a threaded hinge pin 20. Adjusting nut 55 is held in place along a threaded hinge pin 20 by the threads of adjusting nut 55 attached to the threads of threaded hinge pin 20 and by set screw 75. Adjusting nut 60 is held in place along a threaded hinge pin 20 by the threads of adjusting nut 60 attached to the threads of threaded hinge pin 20 and by set screw 80. Door leaf pin barrels 45 and 50 are held in place at the desired location along a threaded hinge pin 20 by adjusting nuts 55 and 60 and respective set screws 75 and 80. An adjustable hinge 10 is attached to a door and respective door jamb by door leaf mounting screws 72 penetrating door leaf screw holes 70 anchoring a door leaf jamb 40 to a door 85 and jamb leaf mounting screws 68 penetrating jamb leaf holes 65 anchoring a jamb leaf 15 to a door jamb 90.

FIG. 4—Additional Embodiment

An additional embodiment is shown in FIG. 4. A jamb leaf 15 is connected to pin barrels 25, 30, and 35. A door leaf is connected to pin barrels 45 and 50. A jamb leaf 15 and a door leaf 40 are connected to one another by a smooth hinge pin 95 which penetrates pin barrels 25, 45, 30, 50 and 35. Shaft collars 100 and 105 are penetrated by a smooth hinge pin 95 in such a manner that shaft collar 100 resides between the bottom of door leaf pin barrel 45 and the top of jamb leaf pin barrel 30 and shaft collar 60 resides between the bottom of door leaf pin barrel 50 and the top of jamb leaf pin barrel 35. A smooth hinge pin 95 is rigidly attached to jamb leaf pin barrels 25, 30 and 35 in such a manner that said smooth hinge pin 95 does not pivot within pin barrels 25, 30 and 35. Openings of door leaf pin barrels 45 and 50 are made large enough to allow pin barrels 45 and 50 and thus door leaf 40 to pivot freely about a smooth hinge pin 95. Door leaf pin barrel 45 is penetrated by a smooth hinge pin 95 in such a manner that it resides between jamb leaf pin barrel 25 and shaft collar 100. Door leaf pin barrel 45 is made short enough in relation to the space between jamb leaf pin barrels 25 and 30 as to allow for vertical movement along a smooth hinge pin 95. Likewise door leaf pin barrel 50 is penetrated by a smooth hinge pin 95 in such a manner that it resides between jamb leaf pin barrels 30 and shaft collar 105. Shaft collar 100 is held in place on a smooth hinge pin 95 by a set screw 110. Shaft collar 105 is held in place on a smooth hinge pin by a set screw 115. Door leaf pin barrels 45 and 50 are held in place at the desired location along a smooth hinge pin 95 by shaft collars 100 and 105 and respective set screws 110 and 115. Door leaf pin barrel 50 is made short enough to allow for vertical movement along a smooth hinge pin 95. An adjustable hinge 10 is attached to a door and respective door jamb by door leaf mounting screws 72 penetrating door leaf screw holes 70 anchoring a door leaf jamb 40 to a door 85 and jamb leaf mounting screws 68 penetrating jamb leaf holes 65 anchoring a jamb leaf 15 to a door jamb 90.

Operation—FIGS. 1,2 and 3

The manner in which one uses an adjustable hinge 10 consists first of attaching the jamb leaf 15 to the door jamb 90 using jamb leaf mounting screws 68 inserted through jamb leaf mounting holes 65. The jamb leaf mounting screws 68 are subsequently driven into the door jamb 90 holding the jamb leaf 15 firmly against the surface of the door jamb 90. The door leaf 40 is attached to the edge of a door 85 by first inserting the door leaf mounting screws 72 through the door leaf mounting holes 70. The door leaf mounting screws 72 are subsequently driven into the edge of the door 85 holding the door leaf 40 firmly against the door 85. Adjusting nuts 55 and 60, being threaded onto the threaded hinge pin 20, will move vertically along the length of the threaded hinge pin 20 by turning them in a clockwise or counter-clockwise direction, depending on the bias of the threads. After the adjustable hinge 10 is mounted to the door 85 and door jamb 90, the height of the door 85 can be adjusted by turning the adjusting nuts 55 and 60 in the direction that facilitates the desired vertical motion, either up or down , of the door. Pressure from the top surfaces of the adjusting nuts 55 and 60 against the bottoms of the door leaf pin barrels 45 and 50 causes the door leaf 40 and thus the attached door 85 to be moved vertically in the same direction as the vertical motion of the adjusting nuts 55 and 60. Once the desired height of the door 85 is reached by turning the adjusting nuts 55 and 60, the adjusting nuts 55 and 60 can be secured by driving the set screws 75 and 80 into the adjusting nuts 55 and 60 and against the threaded hinge pin 20.

### CONCLUSION, RAMIFICATIONS AND SCOPE

The reader will see the mechanism of the invention provides the user with a useful method of adjusting the height of a door without the need for additional machining of the door or door jamb.

While my above description contains many specificities, these should not be construed as limitation on the scope of the invention, but rather as an exemplification of one preferred embodiment thereof. Many other variations are possible. For example, the adjustable hinge can be reversed. It can be installed with the jamb leaf attached to the door and the door leaf attached to the door jamb.

The size and shape of the invention should not be construed to be limited to the preferred embodiment, but may be of any size or shape that would be useful for a particular implementation. For example the size of the adjustable hinge could be scaled down to be useful for small cabinet doors, or scaled up to accommodate large barn doors. The shape could be made in any form that is practical and/or aesthetically pleasing. The adjustable hinge could also be used on lids where the adjustment is needed in the horizontal, instead of the vertical direction.

What is claimed is:

1. A mechanism for adjusting the height of a door, the mechanism comprising:
a) a hinge leaf with attached hinge pin barrels
b) a second hinge leaf, attached to the previously aforementioned hinge leaf by a means which allows the two hinge leafs to rotate in relation to one another through some distance less than or equal to 360 degrees
c) a means of adjusting the vertical distance of one hinge leaf in relation to the other
d) means for attaching said hinge leafs to door and door jamb

2. The mechanism of claim 1 wherein the means of attaching the two hinge leafs together is a threaded hinge pin

3. The mechanism of claim 1 wherein the means of adjusting the vertical distance of one hinge leaf in relation to the other is a threaded adjusting nut

4. The mechanism of claim 1 wherein the means of attaching the two hinge leafs together is a smooth hinge pin

5. The mechanism of claim 1 wherein the means of adjusting the vertical distance of one hinge leaf in relation to the other is a shaft collar and set screw
